(19) United States
(12) Patent Application Publication
(10) Pub. No.: US 2008/0099611 A1
(43) Pub. Date: May 1, 2008

(54) Tail cone for aircraft with movable fairing and support structure for auxiliary power unit and the ancillary elements thereof

(76) Inventors: Esteban Martino Gonzalez, Santander (ES); Pablo Timoteo Sanz Marteniz, Madrid (ES); David Alvaro Granero, Madrid (ES)

Correspondence Address: WENDEROTH, LIND & PONACK, L.L.P., 2033 K STREET N. W., SUITE 800, WASHINGTON, DC, 20006-1021, US

(21) Appl. No.: 11/806,809

(22) Filed: Jun. 4, 2007

(30) Foreign Application Priority Data
Oct. 31, 2006 (ES) 200602770

(51) Int. Cl. B64C 1/00

(52) U.S. Cl. 244/119

(57) ABSTRACT

Tail cone (2) for aircraft (1) with a cover (8) housing an auxiliary power unit (3) and the ancillary systems thereof (6,7), and the cover (8) has a fixed forward section (11) by means of which the tail cone (2) is secured to the rest of the fuselage (4), and a movable fairing (9), housing a support structure (10) secured to the fixed front section (11) which supports the auxiliary power unit (3) and the ancillary systems thereof (6,7). The movable fairing (9) moves by means of folding processes or rather longitudinally by means of telescopic rails (16) secured to the fixed front section (11), from a closed position in which the cover (8) remains closed housing on the inside thereof the support structure (10) with the auxiliary power unit (3) and the ancillary elements thereof (6,7), and an open position in which the cover (8) remains open leaving the support structure (10) with the auxiliary power unit (3) and the ancillary elements thereof (6,7) exposed, affording the possibility of access thereto for purposes of maintenance, repair or replacement.

### TECHNICAL FIELD OF THE INVENTION

This invention pertains to the aeronautical field, more specifically to building of aircraft tails and to the systems for housing the auxiliary power unit and the ancillary elements thereof inside the tail cone, and more specifically to the field of the support structures for said auxiliary power unit and the systems which facilitate access thereto for maintenance tasks.

### STATE OF THE ART PRIOR TO THE INVENTION

Due to the auxiliary power unit being a possible fire focal point, the current trend among most manufacturers is that of locating said auxiliary power unit in the tail cone of the rear fuselage of the aircraft, given that on said tail cone being a secondary structure, any possible damage to or fault thereof would not mean a failure leading to disaster. Therefore, in order to prevent possible fires in the primary structures of the aircraft, the auxiliary power unit is positioned in the tail cone, additionally protecting the rest of the fuselage by means of a firewall bulkhead. In addition to the auxiliary power unit, the tail cone also houses other systems including the air intake and the exhaust pipe, which are systems ancillary to the power unit necessary for the proper working order thereof.

In the tail cone, the requirement of safely housing the auxiliary power unit is, of course, combined with that of providing an appropriate aerodynamic cover which will guarantee the proper working order of the aircraft.

The conventional constructions of the systems which support the auxiliary power unit inside the tail cone consist of a system comprised of a frame of rods or bars secured directly to the semisingle-hull structure of the tail cone. The inside of the tail cone is accessed by way of a door on the underside thereof, and due to the systems which support the auxiliary power unit and to the auxiliary power unit proper, the amount of room left inside is quite small, thus hindering access to all points of the machinery for performing the necessary maintenance and repair tasks. This currently means lengthier maintenance task performance times, resulting in low efficiency and high costs.

In addition to the above, it must be taken into account that the high electrical demand on modern aircraft and the stringent noise-related requirements of the regulations are currently making the auxiliary power units and the ancillary systems thereof increasingly larger in size, which is increasingly worsening the space-related problem.

To provide a solution to this problem, enlarging the size of the tail cone to increase the amount of space inside thereof would not be a feasible solution, given that this would mean a penalization in weight and in aerodynamics which would affect the aircraft flying properly.

In all of these conventional constructions, the tail cone is fixed to the fuselage and is not removed for the auxiliary power unit maintenance and repair tasks. There is a prior design of a sliding tail cone built on an aircraft, but both the system for the building thereof would not solve the problems posed herein, given that, in this case, the tail cone houses a small antenna, which, in conjunction with the electrical equipment, which are much lighter in weight than an auxiliary power unit, rest directly on the rest of the fuselage and not on the tail cone cover.

Therefore, no system exists to date which provides a solution to the problem of supporting the auxiliary power unit and the ancillary systems thereof, meeting all of the safety requirements, in the smallest space possible in order to favor aerodynamics, but which facilitates efficient maintenance and repair of the auxiliary power unit meeting all of the current high requirements.

A system which would provide a solution to the existing problems in the state of the art was therefore desirable.

### DESCRIPTION OF THE INVENTION

This invention is for the purpose of overcoming the drawbacks of the aforementioned state of the art by means of an aircraft tail cone with movable fairing and a support structure for the auxiliary power unit and the ancillary elements thereof.

By means of said tail cone, the auxiliary power unit and the ancillary elements thereof are securely attached to a fixed element of the tail cone, and a movable fairing moves, opening and closing the tail cone, therefore leaving the auxiliary power unit exposed and thus facilitating the auxiliary power unit maintenance and repair tasks. By building the cover in this manner, the movable fairing does not serve as a support structure for the auxiliary power unit and the ancillary elements thereof. Therefore, it is necessary to add an independent structure to support said auxiliary power unit and ancillary elements.

The tail cone comprising the object of this invention comprises a cover housing the auxiliary power unit and the ancillary elements thereof. This cover is comprised of a fixed forward section which serves to attach the tail cone to the rest of the aircraft fuselage, and the movable fairing which affords the possibility of opening and closing the tail cone in order to be able to readily access the interior thereof. The fixed forward section serves to support the movable fairing when it is in the closed position, serving to support, in turn, the aforementioned support structure necessary for supporting the auxiliary power unit and the ancillary elements thereof.

In one embodiment of the fixed forward section, this section is comprised of two ring-frames, one forward and one aft, with a cover panel and rigidizing elements between the two, given that this fixed forward will serve to support the movable fairing when the fairing is in the closed position and serving to support, in turn, the aforementioned support structure necessary for supporting the auxiliary power unit and the ancillary elements thereof.

On the interior of the tail cone is the support structure serving to support the auxiliary power unit and the ancillary systems thereof. This support structure is made of materials resistant to high temperatures for the purpose of being able to withstand the high temperatures which the auxiliary power unit they support reaches, and depending upon the embodiments, takes the form of a frame of different elements. One end of the support structure is secured to the fixed forward section, the opposite end being cantilevered.

In one particular embodiment of the support structure, said structure is comprised of longitudinal and transverse elements.

The movement of the movable fairing to leave the auxiliary power unit exposed may be embodied in different ways.

In different embodiments of the movable fairing, this fairing may be folding and secured to the fixed forward section by way of means of articulation defining a turning axis. To achieve the opening of the cover, the movable fairing turns on this turning axis of the means of articulation, such that it leaves the auxiliary unit and the ancillary elements thereof exposed in order to facilitate access to the same.

In a different embodiment of the movable fairing, likewise based on the folding of elements, said movable fairing is comprised of two symmetrical parts folding laterally which each turn on horizontal axes substantially parallel to the longitudinal axis of the aircraft, arranged in an fixed upper element secured to the upper part of the fixed forward section. On these folding elements turning, the cover is opened and access to the auxiliary power unit and the ancillary elements thereof is allowed.

In a preferred embodiment of the movable fairing, this fairing can move longitudinally along the longitudinal axis of the aircraft between a closed position in which it is attached to the fixed forward section, and the cover is closed and houses the support structure with the auxiliary power unit and the ancillary elements thereof, and an open position in which the movable fairing separated from the fixed forward section and the cover is open, leaving the support structure with the auxiliary power unit exposed and facilitating access for auxiliary power unit maintenance and repair tasks.

In an embodiment based on the embodiment above, which employs the longitudinal movement of the movable fairing, the cover has at its back end an additional movable folding fairing which is attached to the principal movable fairing by additional means of articulation which define a turning axis. Therefore, the movable fairing moves longitudinally, and the additional movable fairing turns on the turning axis and leaves the auxiliary power unit exposed at the rear part of the tail cone.

Another embodiment of the tail cone cover employing longitudinal movement of the movable fairing is by including a fixed end fairing which surrounds the auxiliary power unit exhaust pipe and which is locked to the same, remaining fixed. Therefore, the movable fairing is the central part of the cover and, on moving longitudinally, moves from a closed position in which it is located between the fixed forward section and the fixed end fairing and attached to both thereof, to an open position in which the movable fairing, in its forward movement, separates from the fixed forward section, leaves the fixes final fairing on the inside thereof and moves past the fixed final fairing, the cover being left open and exposing the support structure with the auxiliary power unit.

The longitudinal movement of the movable fairing is achieved by means of some telescopic rails which are secured to the fixed forward section, said movable fairing being attached to the last section of said rails, such that when the telescopic rails extend, the movable fairing easily moves longitudinally.

In the case of the longitudinal movement of the movable fairing, the closing of this movable fairing to the fixed forward section of the tail cone is achieved by means of simple conventional anchoring means providing for fast, easy actuation when it is necessary to open the tail cone cover.

To prevent deformations and failures, the movable fairing includes reinforcement elements such as stringers, half ring-frames or complete ring-frames. Another option consists of covering the movable fairing with sandwich type covers providing it with the necessary rigidity without adding greatly to its weight.

The support structure can be firmly attached by means of metal attachment fittings to the forward ring-frame of the fixed forward section, to the space existing between the forward ring-frame and the aft ring-frame, or the aft ring-frame by means of additional counter-fittings in the space existing between the forward ring-frame and the aft ring-frame for safely transmitting the stresses.

The support structure supports the auxiliary power unit by means of at least three anchoring points, although a larger number thereof may be used, depending upon the degree of steadiness and secureness desired for the system, as well as upon the weight of the unit and upon the vibrations given off thereby. The auxiliary power unit is supported at the top and side thereof, being hung from the support structure. The advantage of this manner of attachment is that it provides for ready access to the unit without the elements of the support structure becoming a hindrance, and the unit can additionally be freed and detached from the support structure, facilitating its being taken down when necessary to repair it out of the assembly or rather to replace it with a new one.

In one particular embodiment, the frame of the auxiliary power unit support structure is comprised of bars and ribs which can be attached to one another in an articulated manner, fixed or semifixed, for which purpose means of welding, adhesive, rivets, bolts, lugs and similar attaching elements may be used. In addition thereto, said bars and ribs can be comprised of one single element or ban be formed by joining different parts to one another. Elastomeric elements are used as vibration dampers at the anchoring points of the auxiliary power unit. These elastomers may be located directly on the inside of the elements comprising the anchoring points of the auxiliary power unit or at the ends of the bars and ribs of the structure supporting said anchoring points.

In the embodiments of the invention in which a longitudinal movement of the movable fairing takes place and telescopic rails are therefore needed, several of the elements comprising the support structure of the auxiliary power unit are used to support these telescopic rails, which ensures the secure attachment thereof, thus preventing their wear. In turn, the telescopic rail sections can serve to reinforce the support structure of the auxiliary power unit, providing the auxiliary power unit with greater sturdiness and rigidity.

In the different embodiments of the invention, both the exhaust pipe and the air intake of the auxiliary power unit are supported by the support structure independently from each power unit. The exhaust pipe is secured by means of conventional fasteners, such as connecting rods, lugs, metal fitting or similar means of attachment; and the air intake is secured either on the support structure or rather on the fixed forward section, or on both, also by means of conventional fasteners.

All of these elements comprise an integrated assembly, the tail cone, which is attached to the rest of the fuselage by means of metal attachment fittings arranged on the forward ring-frame of the fixed forward section and supplementary fittings arranged on the closing ring-frame of the rest of the fuselage. These metal attachment fittings are usually arranged in the same positions in which the metal attachment fittings joining the support structure to the fixed forward section are located.

### BRIEF DESCRIPTION OF THE FIGURES

For a better comprehension of this description and comprising an integral part thereof, some drawings are provided in following on which, for illustrative and non-limiting purposes, the object of the invention has been shown in one of the different embodiments thereof.

FIG. 1 is a view of an aircraft showing the location of the rear fuselage.

FIG. 2 is a view of the rear fuselage shown in FIG. 1, showing the location of the tail cone.

FIG. 3 is a schematic view of the tail cone attached to the rest of the fuselage, showing the auxiliary power unit and the ancillary elements thereof on the interior thereof.

FIG. 4 is a schematic view of one embodiment of the invention showing the tail cone cover and the support structure for the auxiliary power unit and the ancillary elements thereof.

FIG. 5 is a profile view of the embodiment shown in FIG. 4 in which movable fairing is in the open position, allowing access to the auxiliary power unit and the ancillary elements thereof.

FIG. 6 is a profile view of the embodiment shown in FIG. 4 in which movable fairing is in the closed position and covers the auxiliary power unit and the ancillary elements thereof.

FIG. 7 is a profile view of an alternative embodiment of the invention, with the central part of the tail cone cover being movable and the end part of the cover fixed to the moving part, being in the open position and allowing access to the auxiliary power unit and the ancillary elements thereof.

FIG. 8 is a profile view of the embodiment shown in FIG. 7, in which the moving part is in the closed position, covering the auxiliary power unit and the ancillary elements thereof.

FIG. 9 shows an embodiment of the support structure of the auxiliary power unit and the ancillary elements thereof.

FIG. 10 shows an alternative embodiment of the support structure of the auxiliary power unit and the ancillary elements thereof.

FIG. 11 is a view of the embodiment shown in FIG. 4 showing the assembly of the invention with the fixed element, the movable fairing in closed position, the rails and the support structure of the auxiliary power unit and the ancillary elements thereof.

FIG. 12 is a view similar to FIG. 10, except that in this case the movable fairing is in the open position.

FIG. 13 shows a detail of the system of supports for the rails on the ring-frames of the fixed forward section and the intermediate supports of these rails on the support structure.

FIG. 14 shows the relative position and the attachment of the movable fairing and the rails.

FIG. 15 is a view of an embodiment of the fixed forward section of the tail cone cover showing the two ring-frames, the cover panel between the two and the rigidizing elements.

FIG. 16 is an overview of the assembly of the invention showing the position of the attachment points of the movable fairing to the fixed forward section of the tail cone.

FIG. 17 shows the details of an embodiment of the attachment points of the movable fairing to the fixed forward section of the tail cone, in the closed position at the top and in the bottom.

FIG. 18 is a schematic view showing the attachment points of the support structure of the auxiliary power unit and the ancillary elements thereof to the fixed forward section of the tail cone.

FIG. 19 shows a particular embodiment of the metal attachment fittings of the support structure to the fixed forward section of the tail cone as well as of the attachment elements of said tail cone to the rest of the fuselage.

FIG. 20 shows an alternative embodiment of the metal attachment fittings of the support structure to the fixed forward section of the tail cone, in conjunction with the attachment elements of said tail cone to the rest of the fuselage shown in the immediately preceding figure.

FIG. 21 is a front view of the attachment points of the tail cone and the rest of the fuselage on the closing ring-frame for the rest of the fuselage.

FIG. 22 is a front view of the attachment points of the tail cone and the rest of the fuselage on the closing ring-frame of the fixed front section of the tail cone.

FIG. 23 is a view of the tail cone shown completely separated from the rest of the fuselage, showing the attachment elements of both assemblies.

FIG. 24 is a schematic view of an embodiment of the invention in which a longitudinal movement of the movable fairing and a front folding of an additional movable fairing is produced.

FIG. 25 shows an alternative embodiment of the movable fairing in which said fairing does not move longitudinally but rather folds frontally by turning on an axis perpendicular to the longitudinal axis of the aircraft.

FIG. 26 shows another alternative embodiment of the movable fairing in which two side elements fold laterally by each turning on axes substantially parallel to the longitudinal axis of the aircraft.

Numerical references are included in these figures denoting the following elements:
1. Aircraft
2. Tail cone
3. Auxiliary power unit
4. Rest of the fuselage
5. Firewall bulkhead
6. Air intake of the auxiliary power unit
7. Exhaust pipe of the auxiliary power unit
8. Tail cone cover
9. Movable fairing
10. Support structure of the auxiliary power unit and the ancillary elements thereof
11. Fixed forward section of the tail cone
12. Forward ring-frame of the fixed forward section of the tail cone
13. Aft ring-frame of the fixed forward section of the tail cone
14. Cover panel of the fixed forward section
15. Rigidizing elements
16. Telescopic rails
17. Intermediate supports
18. Closing ring-frame of the movable fairing
19. Attachment anchorings
20. Fixed end fairing of the tail cone cover
21. Metal attachment fittings of the support structure and the fixed forward part of the tail cone
22. Longitudinal elements
23. Transverse elements
24. Forward fasteners of the auxiliary power unit
25. Rear fasteners of the auxiliary power unit
26. Primary fittings on the tail cone
27. Secondary fittings on the rest of the fuselage
28. Fixed section of the telescopic rails
29. Movable sections of the telescopic rails
30. Half ring-frames for supporting the telescopic rails
31. Metal attachment fittings for rails and supporting half ring-frames
32. Closing ring frame for the rest of the fuselage
33. Exhaust pipe fasteners
34. Means of attachment for the support structure elements
35. Rear fuselage
36. Additional movable fairing
37. Means of articulation
38. Additional means of articulation
39. Primary lateral movable fairing
40. Secondary lateral movable fairing
41. Upper fixed element
42. Primary lateral means of articulation
43. Secondary lateral means of articulation

### EMBODIMENTS OF THE INVENTION

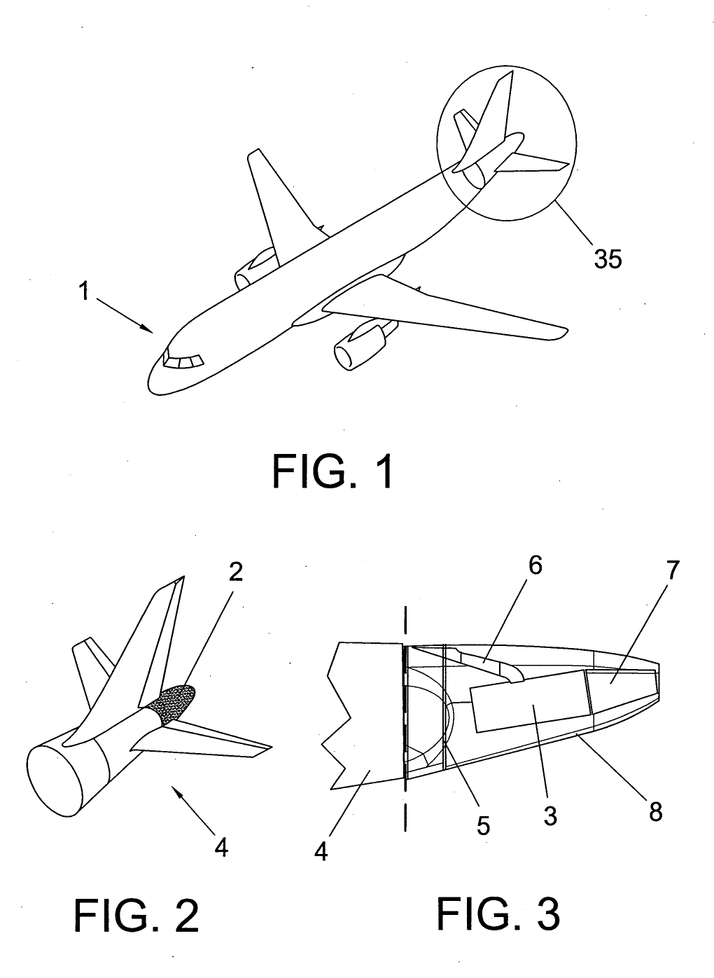

FIGS. 1 and 2 show an overview of the arrangement of the tail cone 2 on the rear fuselage 35 of an aircraft 1. On said tail cone, the auxiliary power unit 3 and the ancillary elements thereof such as the air intake 6 and the exhaust pipe 7 are located. FIG. 3 shows a conventional embodiment of said tail cone 2 on which a firewall bulkhead 5 safeguards the rest of the fuselage 4 against possible risks of fire.

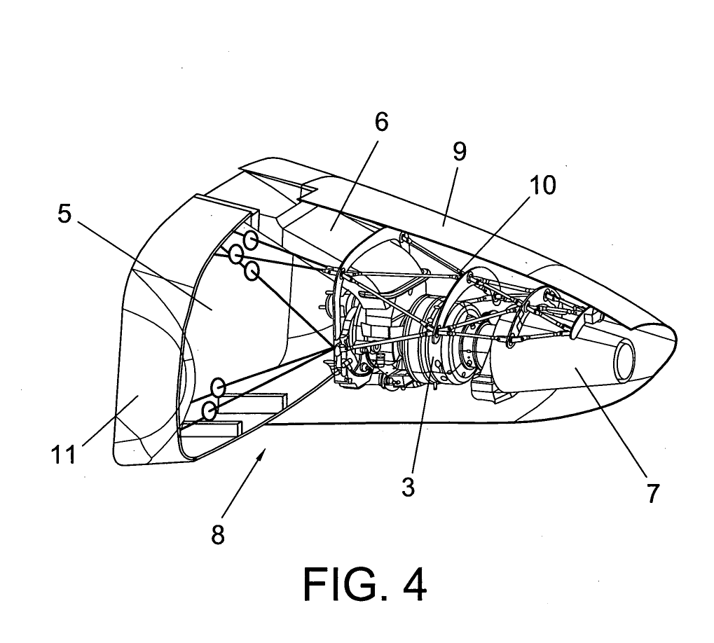

FIG. 4 shows an embodiment of the tail cone 2 comprising the object of the invention. The tail cone 2 comprises a cover 8 which houses an auxiliary power unit 3 and an assembly of systems ancillary thereto, such as an air intake 6 and an exhaust pipe 7. The cover of the tail cone 2 is comprised of a fixed forward section 11 and a movable fairing 9.

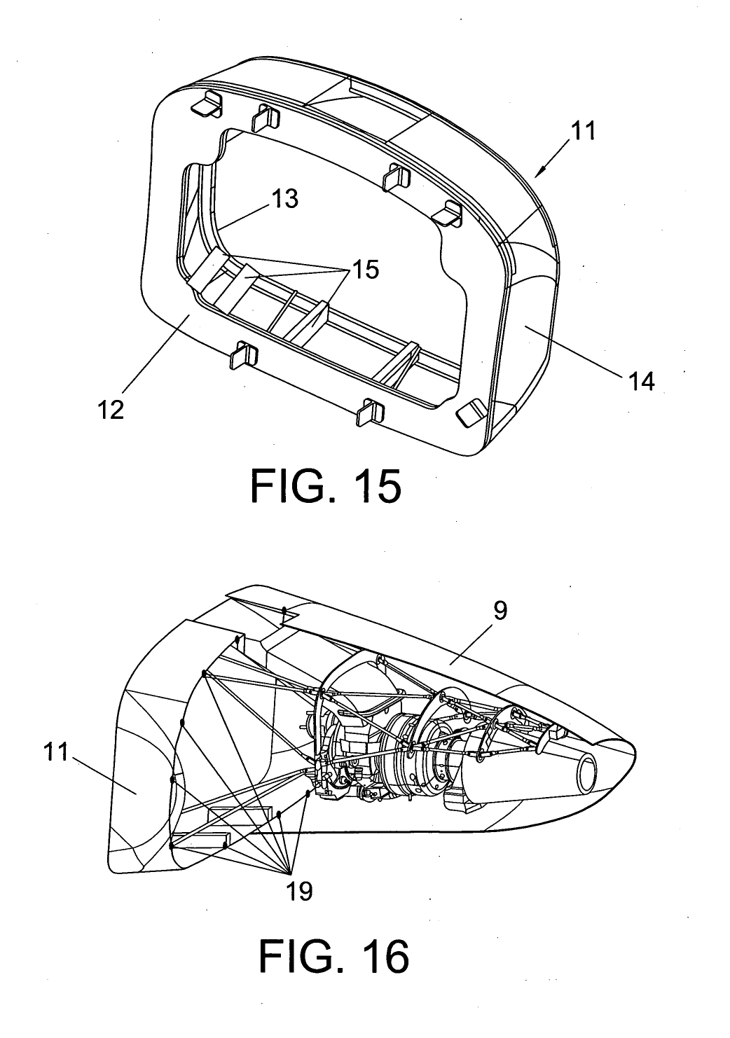

The fixed forward section 11 joins the tail cone 2 to the rest of the fuselage 4, and as is shown in FIG. 15, in a particular embodiment of said fixed forward section 11, said section is comprised of a forward ring-frame 12 and a aft ring-frame 13, and a cover panel 14 positioned between the two ring-frames, in conjunction with rigidizing elements 15. This embodiment of the fixed forward section 11 provides said section with the necessary rigidity and sturdiness yet without adding too much to the weight of the aircraft 1. In a preferred embodiment of the fixed forward section 11, said section is perpendicular to the longitudinal axis of the aircraft 1, although it may also be embodied at a different slant from the longitudinal axis.

The cover 8 houses a support structure 10 which serves to support the auxiliary power unit 3 and the ancillary elements thereof.

In one particular embodiment of the invention, this support structure 10 is comprised of an assembly of longitudinal 22 and transverse 23 elements. These longitudinal 22 and transverse 23 elements are made of material resistant to high temperatures due to the high temperatures which the auxiliary power unit reaches and the risk of the same catching on fire.

One of the main characteristics of the invention is the movable fairing 9, which makes it possible to close and open the cover 8 of the tail cone 2 and allows access to the auxiliary power unit 3 for the maintenance, repair or replacement thereof.

The movement of the movable fairing 9 to leave the auxiliary power unit 3 exposed may be achieved in very different ways.

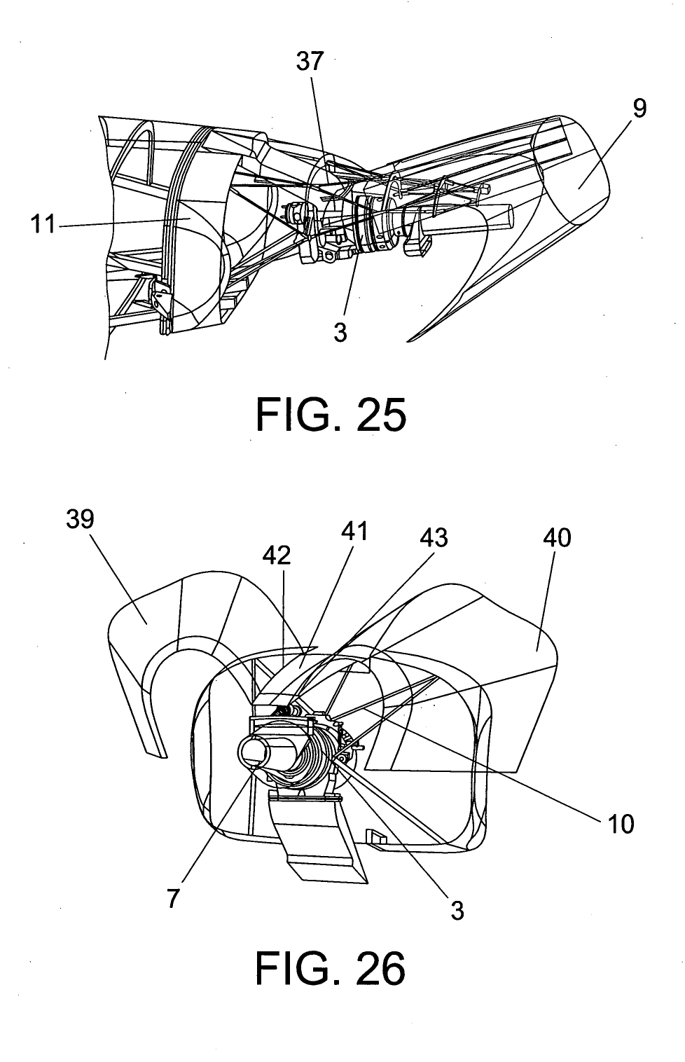

In one embodiment of the movable fairing 9, said movable fairing 9 is front-folding, moving by means of turning and leaving the auxiliary power unit exposed or concealed. FIG. 25 shows this embodiment. In said figure, it is shown that a front-folding movable fairing 9 is attached to the fixed forward section 11 by way of means of articulation 37 which define a horizontal turning axis perpendicular to the longitudinal axis of the aircraft 1. The folding movable fairing 9 turns on said axis by way of means of articulation 37, being able to go move from a closed position in which the cover 8 houses the support structure 10 with the auxiliary power unit 3, to an open position in which the support structure 10 and the auxiliary power unit 3 are exposed, allowing access thereto.

In different embodiments of the invention, the movable fairing 9 may be laterally foldable according to a turning axis parallel to the longitudinal axis of the aircraft 1, or even folding according to a turning axis in any direction.

FIG. 26 shows an embodiment of the movable fairing 9 likewise based on folding elements. In this case, as shown in said figure, the movable fairing 9 is comprised of a primary lateral movable fairing 39 and a secondary lateral movable fairing 40. Both movable fairings 39, 40 are laterally-folding. In this embodiment, there is a fixed upper element 41 attached to the fixed forward section 11, and both movable fairings 39,40 are arranged at both side of said upper fixed element 41 symmetrically to a vertical plane through which the longitudinal axis of the aircraft 1 runs. The primary lateral movable fairing 39 is attached to the upper fixed element 41 by means of primary lateral means of articulation 42, and the secondary lateral movable fairing 40 is attached to the upper fixed element 41 by means of secondary lateral means of articulation 43. The lateral means of articulation 42, 43 each define a turning axis, such that, as is shown in FIG. 26, the primary lateral movable fairing 39 turns on the turning axis defined by the primary lateral means of articulation 42, and the secondary lateral movable fairing 40 turns on the turning axis defined by the secondary lateral means of articulation 43, the cover 8 thus moving from a closed position to an open position in which the support structure 10 and the auxiliary power unit 3 are exposed.

In a preferred embodiment of the movable fairing 9, said fairing moves longitudinally from a closed position in which said movable fairing 9 is attached to the fixed forward section 11 and the cover 8 remains closed such that it houses the support structure 10 with the auxiliary power unit 3 inside, and an open position in which the movable fairing 9 separates from the fixed forward section 11 and the cover 8 remains open leaving the support structure with the auxiliary power unit 3 and the ancillary elements thereof exposed, allowing any operator fast, easy access for the inspection, maintenance or repair of said auxiliary power unit 3.

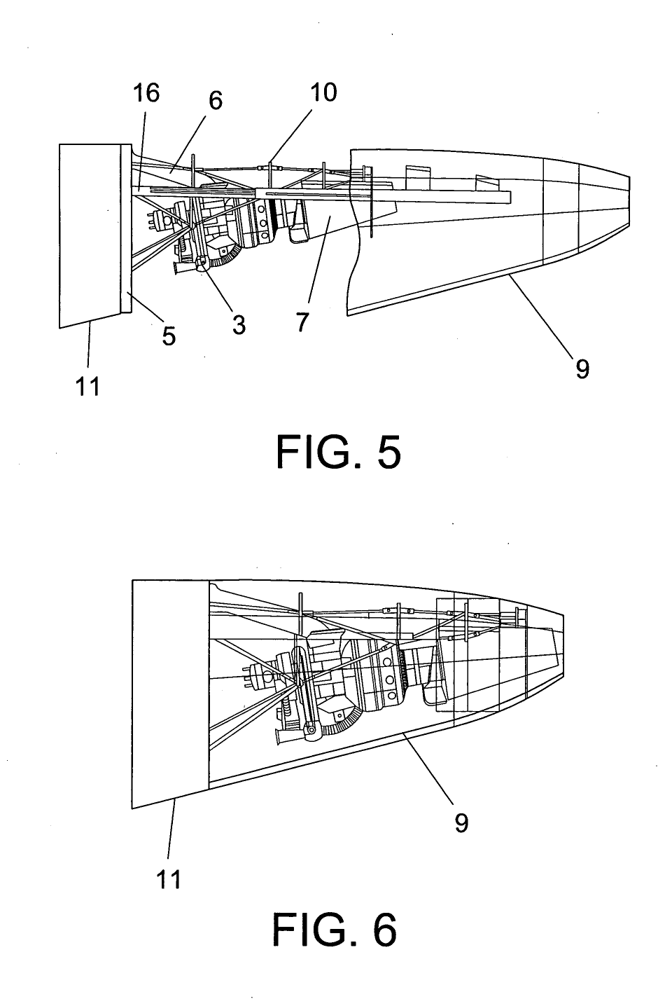

FIG. 5 shows this embodiment of the invention by way of longitudinal movement of the movable fairing 9, in which the cover 8 of the tail cone 2 is in the open position, it being shown that the support structure 10 and the auxiliary power unit 3 are exposed and readily accessible for the handling thereof. Complementarily, FIG. 6 shows the cover 8 of the tail cone 2 comprising the object of the invention in the closed position, where, for purposes of clarity, the movable fairing 9 has been drawn transparently in order to show that the support structure 10 with the auxiliary power unit are thus located inside.

Therefore, this embodiment of the tail cone 2 by way of a movable fairing 9, provides a system for easily removing the cover 8 from said tail cone 2 and facilitating access to the auxiliary power unit 3 for the inspection, maintenance and repair thereof, whilst the support structure 10 also provides a simple, safe system for supporting the auxiliary power unit 3, which is necessary with this configuration, given that the movable fairing 9 no longer serves to structurally support the auxiliary power unit 3, a suitable support being needed for said auxiliary power unit, the system overall therefore serving this twofold purpose of supporting the auxiliary power unit 3 and of mobility to facilitate access to the auxiliary power unit for maintenance and repair tasks.

FIG. 24 shows an alternative embodiment of the invention with longitudinal movement of the movable fairing 9, in which a folding of an additional movable fairing 36 attached to the movable fairing 9 by way of additional means of articulation 38 define a horizontal turning axis perpendicular to the longitudinal axis of the aircraft 1, and the additional movable fairing 36 turns on said turning axis leaving the support structure 10 and the auxiliary power unit 3 and the ancillary elements thereof 6,7 exposed at the rear of the tail cone 2.

Likewise, according to other embodiments of the invention, the additional movable fairing 36 can be folding according to a turning axis parallel to the longitudinal axis of the aircraft 1, or even folding according to a turning axis in any direction.

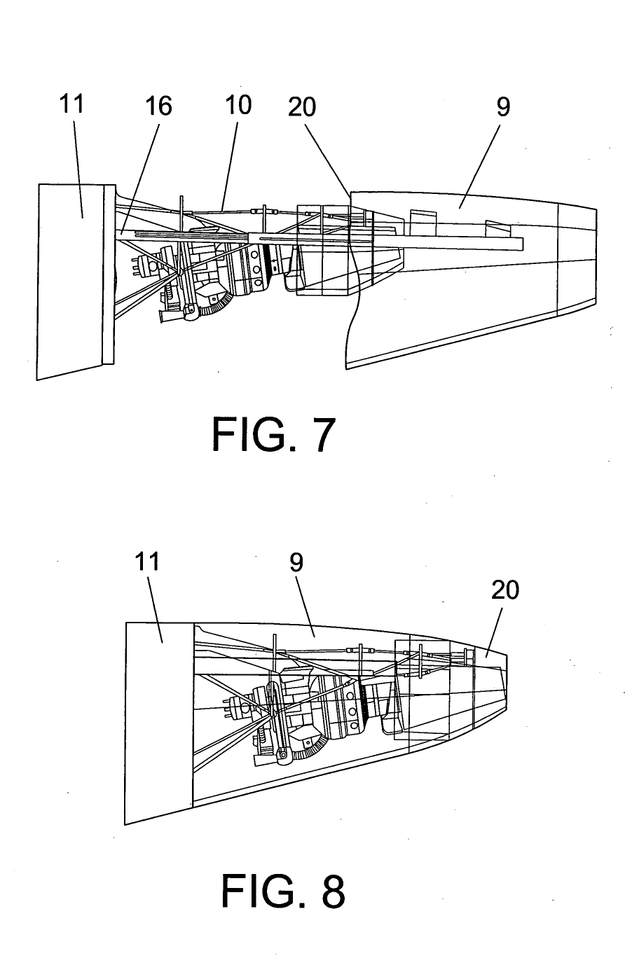

FIGS. 7 and 8 show another alternative embodiment of the invention with longitudinal movement of the movable fairing 9, in which a fixed end fairing 20 is added to the cover 8 at the rear thereof, directly beyond the movable fairing 9. This fixed end fairing 20 surrounds the exhaust pipe 7 and is locked thereto, remaining permanently fixed. By way of this embodiment, the movable fairing 9, as shown in FIG. 8, when in its closed position remains between the fixed forward section 11 and the fixed end fairing 20 and in contact with both thereof. Said movable fairing 9, in its longitudinal movement along the longitudinal axis of the aircraft 1, separates from the fixed section 11 and leaves the fixed end fairing 20 on the interior thereof, moving past the same and reaching the open position, which is shown in FIG. 7, leaving the support structure 10 with the auxiliary power unit 3 and the ancillary elements thereof exposed for allow access thereto.

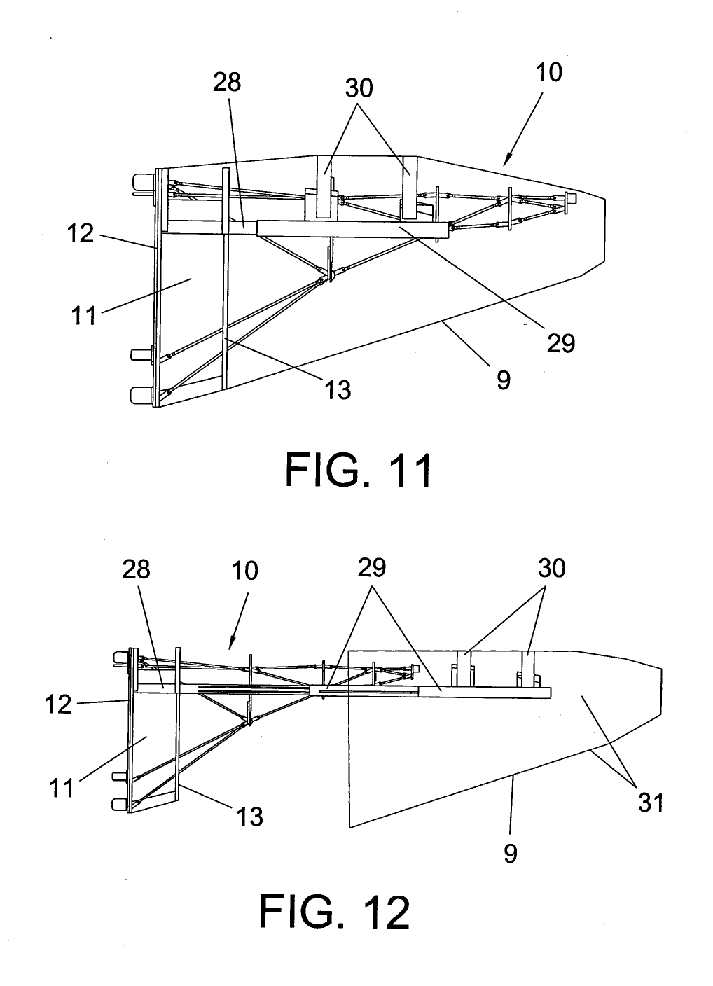

In any of the embodiments which entail longitudinal movement of the movable fairing 9, each one of the telescopic rails 16 is comprised of a fixed section 28 which is that which is secured to the fixed forward section 11, and a number of movable sections 29 attached to the movable fairing 9, which, in their movement, cause the movement of said movable fairing 9. This embodiment provides the advantage of it being made possible to remove the cover 8 for accessing the auxiliary power unit 3 by way of a simple, gentle movement. FIG. 11 shows both sections 28, 29 and the cover 8 in the closed position. FIG. 12 shows the sections 29 extended and the cover 8 in the open position.

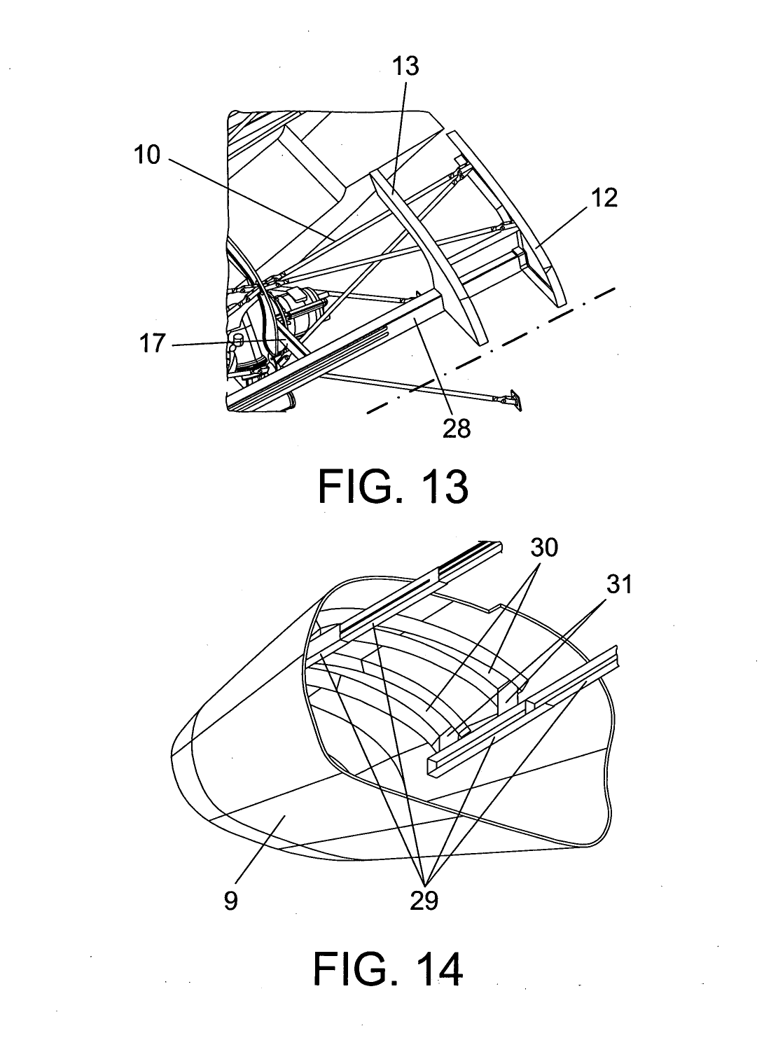

FIG. 13 shows the way in which the fixed section 28 of the telescopic rails 16 is attached to the fixed forward section 11 of the cover 8 of the tail cone 2. For the purpose of achieving a high degree of safety and stability, the fixed section 28 is secured to the forward ring-frame 12 and to the rear ring frame 13 of said fixed forward section 11. FIG. 14 shows the attachment of the movable sections 29 of the telescopic rails 16 to the movable fairing 9. As is shown in said FIG. 14, the movable fairing 9 is has a number of ring frames or half ring-frames 30 on the inside thereof, which in addition to serving the purpose of providing said movable fairing 9 with rigidity, are used for securing the movable sections 29 of the telescopic rails by way of metal attachment fittings 31 arranged on said movable sections.

In order to achieve the necessary rigidity in the movable fairing 9, in addition to the half ring-frames 30, the movable fairing 9 comprises additional reinforcement elements such as ring frames or stringers. Another alternative way of achieving this added reinforcement is by way of a sandwich type cover which directly provides the necessary rigidity. Thus a certain degree of rigidity and sturdiness is provided without greatly adding to the weight of the assembly.

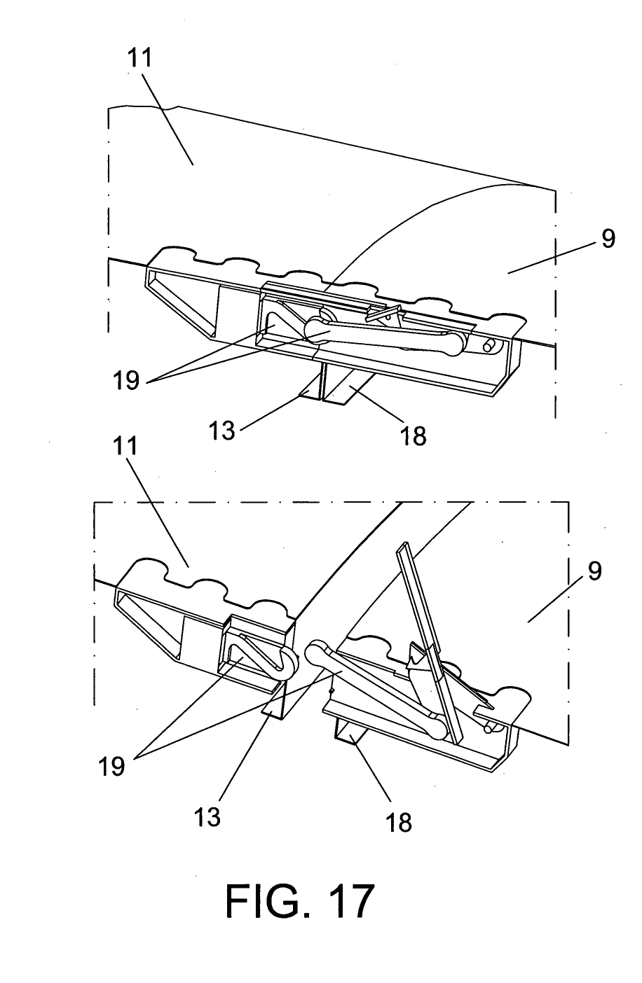

In the preferred embodiments of the invention, in which there is a longitudinal movement of the movable fairing 9, in the closed position, the attachment of the movable fairing 9 to the fixed forward section 11 is made by means of a closing ring frame 18 of the movable fairing which is secured to the aft ring-frame 13 of the fixed forward section by means of conventional attachment anchorings 19, as is shown in FIG. 16, which are actuated fast and simply, which makes the longitudinal movement of the movable fairing 9 and the opening of the cover 8 of the tail cone 2 possible. FIG. 17 shows an example of the embodiment of said conventional attachment anchorings in the closed and open positions.

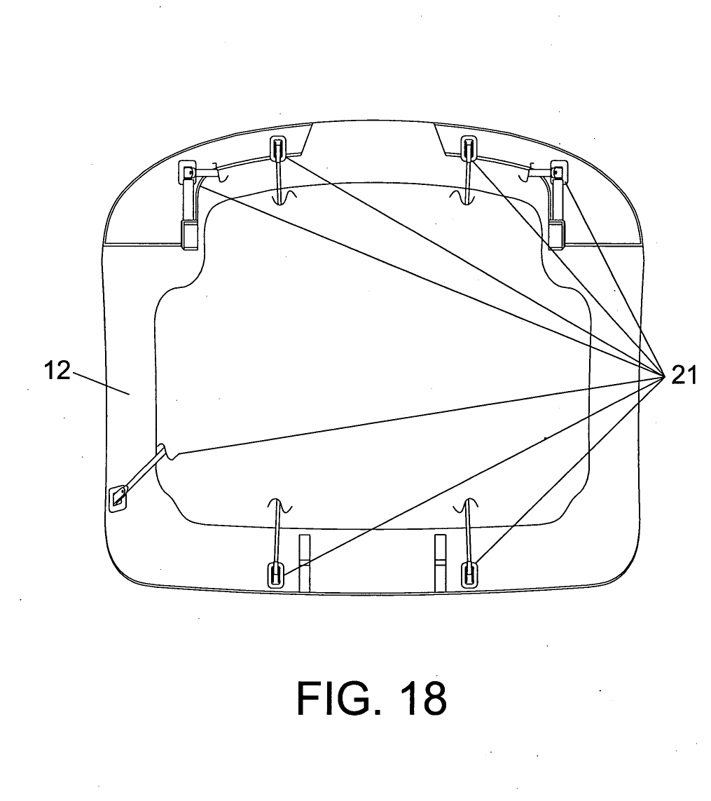

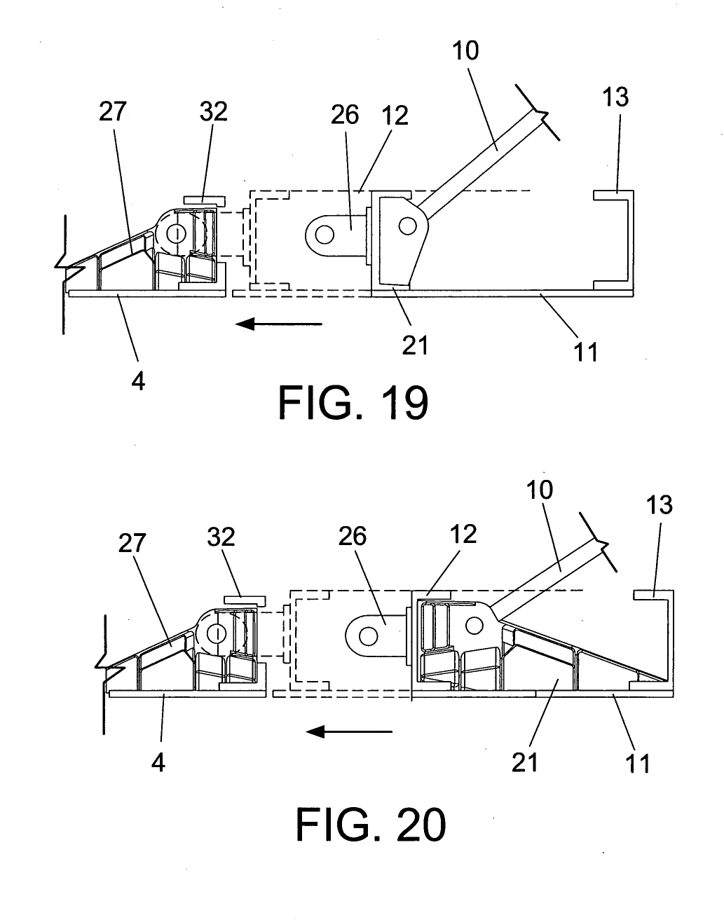

Regarding the support structure 10, which supports the auxiliary power unit 3 and the ancillary elements thereof, said structure is secured to the fixed forward section 11 by means of a set of metal attachment fittings 21, as is schematically diagrammed in FIG. 18. In this case, and also shown in FIG. 19, the support structure 10 is secured directly to the forward ring-frame 12 of said fixed forward section 11.

FIG. 20 shows an alternative embodiment of the attachment of the support structure 10 to the fixed forward section 11, in which said support structure 10 is attached between the forward ring-frame 12 and the aft ring-frame 13 of the forward section by means of the metal attachment fittings 21. This second embodiment of the attachment provides for a firmer anchoring thanks to the fitting placed between two ring-frames.

In another additional embodiment of the attachment of the support structure 10, said structure is attached to the aft ring-frame 13 of the fixed forward section 11 by means of conventional metal attachment fittings 21, there being counter-fittings between the forward ring-frame 12 and the aft ring-frame 13 to safely transmit the stresses.

Thus, the support structure 10 is attached to the tail cone 2 in a totally secure manner and can serve the purpose of supporting the auxiliary power unit 3 and the ancillary elements thereof.

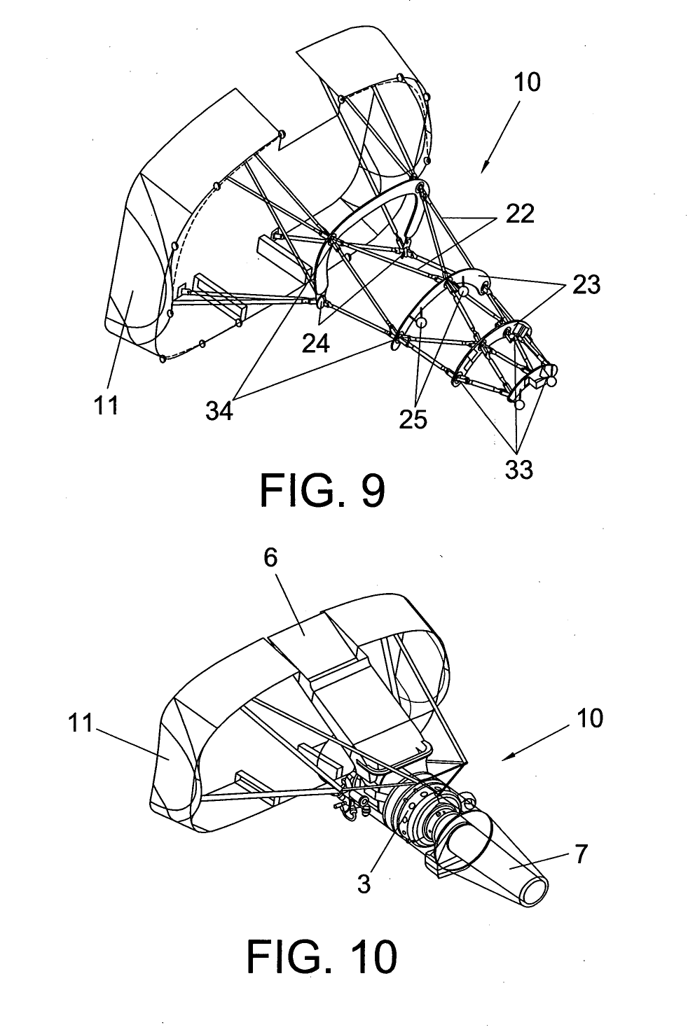

The support structure 10 supports the auxiliary power unit 3 by the upper part and the sides the same, by means of at least three anchoring points on the forward fasteners 24 and rear fasteners 25 of said auxiliary power unit 3, although more anchoring points could be used, depending upon the size of the unit, as well as on the weight and the vibrations caused, and on the desired degree of steadiness and secureness. The advantage provided by this embodiment is the secureness of the support as the same time as a ready accessibility to the auxiliary power unit 3 when it is necessary to handle this unit, given that, on being fastened by its upper and side part, the operators will have free access and will not be hindered by the support unit 10 proper. Additionally, this configuration facilitates the task of easily taking down and removing the unit when it is necessary to repair it out of the assembly or rather to replace it with another. FIG. 9 details all of the elements which provide the securing into place of the auxiliary power unit 3.

As is shown in said FIG. 9, in a preferred embodiment of the support structure 10, the longitudinal elements 22 are bars, and the transverse elements 23 are ribs, which approximately adapt to the upper shape of the auxiliary power unit and enclose the same, thus facilitating the securing thereof.

FIG. 10 shows an alternative embodiment of the support structure 10 in which both the longitudinal 22 as well as the transverse 23 elements are bars.

The attachment of these elements 22, 23 which comprise the framing constituting the support structure 10 can be made by way of conventional means such as welding, adhesive, rivets, lugs, bolts or similar means of attachment. By way of these means of attachment 34, different attachments are achieved, some being fixed without any leeway of movement, others semifixed and others articulated for the purpose of absorbing stresses and strains transmitted by the auxiliary power unit 3. Likewise, in different embodiments of the support structure 10, each one of the elements 22, 23 comprising the same can be made either in one single piece, which will provide the assembly with simplicity and sturdiness, or rather can be made by joining together different parts, which will facilitate maintenance and replacement of worn or damaged elements 22, 23 of the support structure 10.

The functioning of the auxiliary power unit 3 produces vibrations, and these vibrations are transmitted to the support structure 10, and through the same to the fixed forward section 11 of the tail cone 2. In order to prevent damage by way of wear and fatigue due to the vibrations, the embodiment of the invention takes in including elastomeric elements as dampers of the vibrations at the anchoring points of the auxiliary power unit 3. These elastomers may be located directly on the inside of the elements forming the anchoring points of the auxiliary power unit 3 or on the ends of the bars and ribs of the support structure 10 which support said anchoring points.

This support structure 10, in addition to serving the purpose of supporting the auxiliary power unit 3 and the ancillary elements thereof 6, 7, is used as a support for the telescopic rails 9 and the opening and closing of the cover 8 of the tail cone 2, as shown in FIG. 13. Thus, the telescopic rails do not undergo wear due to the weight of the movable fairing 9, a greater degree of stability and a lesser degree of vibration in the movement of said movable fairing 9 thus being achieved. In turn, the sections of telescopic rails 16 can serve to reinforce the support structure 10 of the auxiliary power unit 3 by providing a greater degree of rigidity and strength of the same.

The exhaust pipe is secured in place by means of conventional fasteners such as pin, lugs, metal fittings or similar means of attachment, and the air intake is secured either on the support structure or on the fixed forward section, or on both, also by means of conventional fasteners.

As previously stated hereinabove, in addition to supporting the auxiliary power unit 3, this support structure 10 supports the exhaust pipe 7 and the air intake 6 attached to the same and necessary for the proper functioning thereof. In a preferred embodiment, the exhaust pipe 7 is supported by the support structure 10 independently from the auxiliary power unit 3 by means of conventional exhaust pipe 37 fasteners such as lugs, pins or similar means of attachment. Additionally, the air intake is supported independently from the auxiliary power unit 3, either on the support structure 10 or on the fixed forward section 11 of the fail cone 2 or on both, also by means of conventional fasteners. This embodiment facilitates the maintenance, repair or even replacement of any of these ancillary elements at any point in time independently of the auxiliary power unit 3. Moreover, due to the independent fasteners of these elements with the support structure 10, it is made possible for no internal strains due to the heat expansion of the auxiliary power unit 3 and the ancillary elements thereof 6,7 to be generated.

All of the elements described hereinabove, integrated into one sole assembly, form the tail cone 2, independent from the rest of the fuselage 4, to which it can be attached once said tail one 2 is fully mounted.

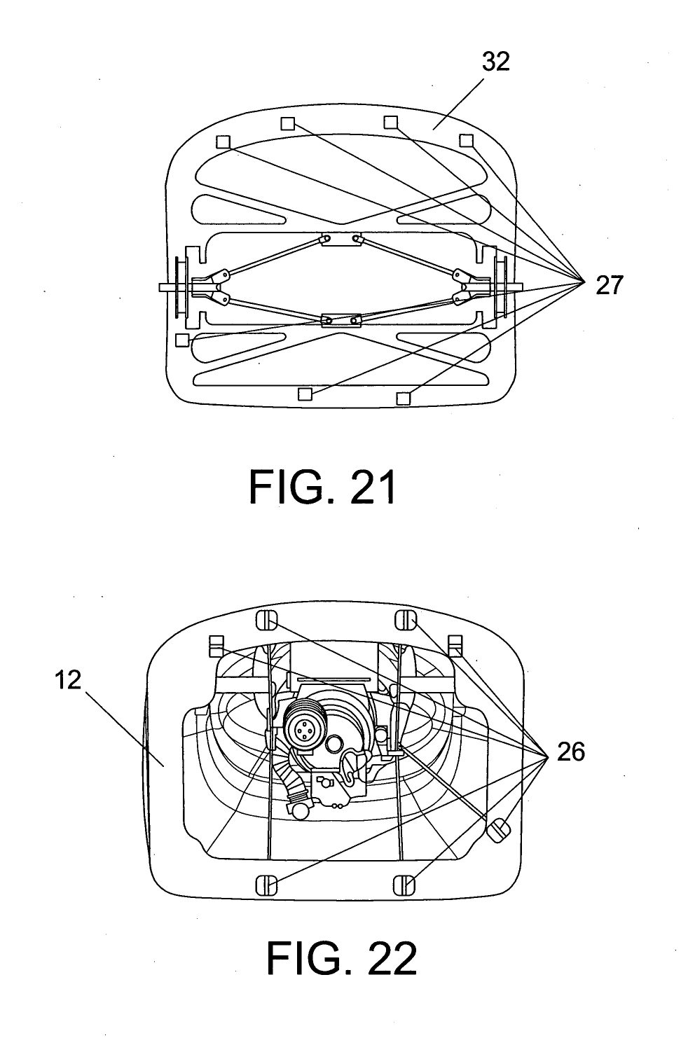

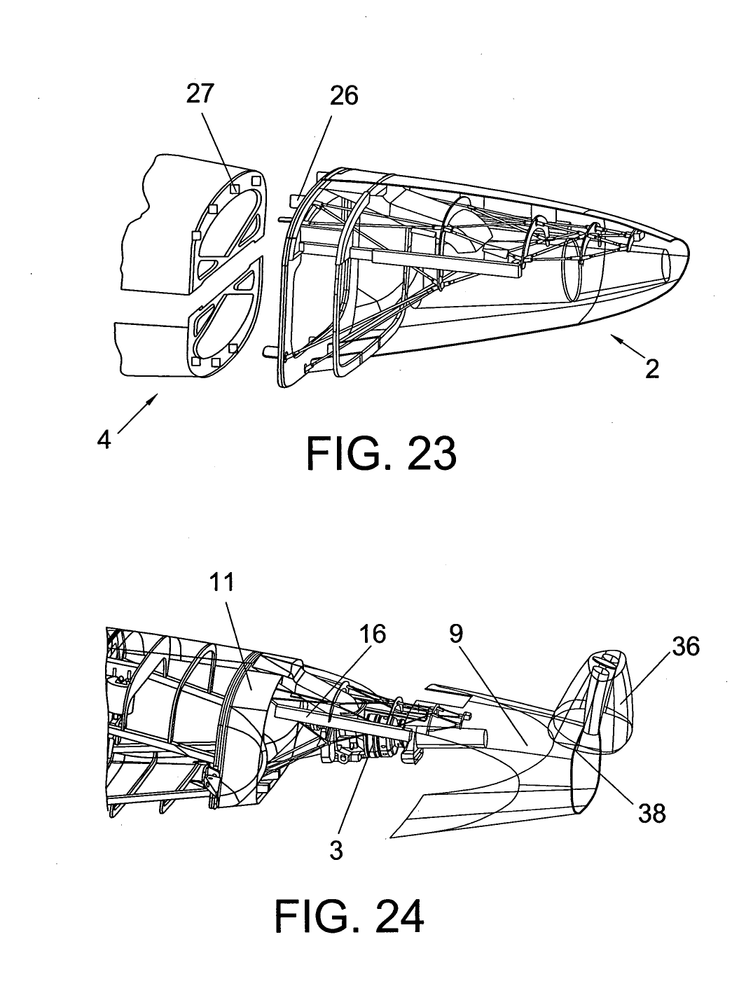

For said attachment, the rest of the fuselage has a closing ring-frame 32 at the rear thereof to which the forward ring-frame 12 of the fixed forward section of the tail cone 2 will be attached. For this purpose, the forward ring-frame 12 has some primary metal fittings 26 and the closing ring-frame 32 has some secondary fittings 27 supplementary to the primary fittings 26, the set of fittings 26, 27 providing a simple, effective attachment. FIGS. 21 and 22 show the primary fittings 26 of the forward ring-frame of the fixed forward section 11 and the secondary fittings of the closing ring-frame 32 of the rest of the fuselage 4, and FIG. 23 generally shows the attachment of the tail cone 2 to the rest of the fuselage 4 by means of the fittings 26, 27.

The primary fittings 26 may additionally comprise counter-fittings for the purpose of transmitting the stresses received to the fixed forward section 11 of the tail cone 2, and the secondary fittings 27 may additionally comprise counter-fittings for the purpose of transmitting the stresses received, in this case, to the rest of the fuselage 4.

In a preferred embodiment of the invention, the positions of the primary metal attachment fittings 26 existing on the forward ring-frame 12 of the fixed forward section 11 for attaching the tail cone 2 to the rest of the fuselage 4 coincide with the positions of the metal attachment fittings 21 of the fixed forward section 11 for attaching the support structure 10 to said fixed forward section 11.

Another embodiment of the attachment between the rest of the fuselage 4 and the tail cone 2 consists of a continuous circumferential attachment which directly attaches the covers of the tail cone 2 to the covers of the rest of the fuselage 4, adding the reinforcement elements necessary to achieve the necessary firmness for said attachment.

1. Tail cone for aircraft, which comprises a cover which houses an auxiliary power unit and an assembly of ancillary systems comprising an air intake and an exhaust pipe, said tail cone wherein the cover comprises a fixed forward section which attaches the tail cone to the rest of the fuselage, and a movable fairing, said cover housing a support structure comprised of a set of elements and secured to the fixed forward section, said support structure supporting the auxiliary power unit and the ancillary elements thereof, the movable fairing moving between a closed position in which said movable fairing is attached to the fixed forward section and the cover remains closed housing on the interior thereof the support structure and the auxiliary power unit and the ancillary elements thereof, and an open position in which the cover remains open leaving the support structure and the auxiliary power unit and the ancillary elements thereof exposed and allowing access to the same.

2. Tail cone for aircraft, according to claim 1, wherein the fixed forward section comprises a forward ring-frame and an aft ring-frame, and a cover panel and rigidizing elements between the forward ring-frame and the aft ring-frame.

3. Tail cone for aircraft, according to claim 1, wherein the movable fairing moves longitudinally by means of telescopic rails secured to the fixed forward section, said telescopic rails being arranged longitudinally of the aircraft, between the closed position in which said movable fairing is attached to the fixed forward section and the cover remains closed housing on the inside thereof the support structure, the auxiliary power unit and the ancillary elements thereof, and the open position in which said movable fairing is separated from the fixed forward section and the cover remains open leaving the support structure and the auxiliary power unit and the ancillary elements thereof exposed and allowing access to the same.

4. Tail cone for aircraft, according to claim 1, wherein the cover comprises, at the rear end thereof, a folding additional movable fairing, said additional movable fairing attached to the movable fairing by way of additional means of articulation which comprise a turning axis, the additional movable fairing turning around the turning axis of the additional means of articulation leaving the support structure and the auxiliary power unit and the ancillary elements thereof exposed at the rear part of the tail cone.

5. Tail cone for aircraft, according to claim 4, wherein the additional movable fairing is front-folding, said additional movable fairing being attached to the movable fairing by way of additional means of articulation which comprise a horizontal turning axis perpendicular to the longitudinal axis of the aircraft, the additional movable fairing turning around the horizontal turning axis of the additional means of articulation.

6. Tail cone for aircraft, according to claim 3, wherein the cover of the tail cone comprises at the rear part thereof, a fixed end fairing which surrounds the exhaust pipe of the auxiliary power unit and is locked thereto and remains fixed, being the central part of the cover of the movable fairing, said movable fairing moving longitudinally, leaving the fixed end fairing inside thereof, between the closed position in which it remains between the fixed forward section and the fixed end fairing attached to the fixed forward section and the fixed end fairing, and the open position which it is separated from the fixed forward section having moved past the fixed end fairing and the cover remains open leaving the support structure and the auxiliary power unit exposed and allowing access to the same.

7. Tail cone for aircraft, according to claim 3, wherein each one of the telescopic rails comprises a fixed section which is attached directly to the fixed forward section, resting on the forward ring-frame and on the aft ring-frame thereof, and a number of sliding movable sections, the last of said movable sections being attached to half ring-frames or to complete ring-frames secured to the movable fairing by means of metal attachment fittings.

8. Tail cone for aircraft, according to claim 2, wherein the movable fairing comprises at the end thereof attached to the fixed forward section a closing ring-frame which is secured to the aft ring-frame of said fixed forward section by means of conventional attachment anchorings.

9. Tail cone for aircraft, according to claim 1, wherein the movable fairing is folding, and said movable fairing is attached to the fixed forward section by way of means of articulation which comprise a turning axis, the movable fairing turns on said turning axis of the means of articulation, between a closed position in which said movable fairing is attached to the fixed forward section and the cover remains closed housing on the inside thereof the support structure and the auxiliary power unit, and an open position in which the cover remains open, leaving the support structure and the auxiliary power unit and the ancillary elements thereof exposed and allowing access to the same.

10. Tail cone for aircraft, according to claim 9, wherein the movable fairing is front-folding, said movable fairing being attached to the fixed forward section by way of means of articulation which comprise a horizontal turning axis perpendicular to the longitudinal axis of the aircraft, the movable fairing turning around said horizontal turning axis of the means of articulation.

11. Tail cone for aircraft, according to claim 1, wherein the cover comprises a upper fixed element attached to the fixed forward section at the top thereof, and the movable fairing comprises a primary lateral movable fairing and a secondary lateral movable fairing which are side-folding, and located to the side of the upper fixed element symmetrically to a vertical plane through which the longitudinal axis of the aircraft runs, the primary lateral movable fairing and the secondary lateral movable fairing being attached to the upper fixed element by means of primary lateral means of articulation and secondary lateral means of articulation respectively, said lateral means of articulation each comprising turning axes oriented in the longitudinal direction of the aircraft, the primary lateral movable fairing turning on the turning axis of the primary lateral means of articulation and the secondary lateral movable fairing on the turning axis of the secondary lateral means of articulation, between a closed position in which said movable fairing is attached to the fixed forward section and the cover remains closed housing on the inside thereof the support structure and the auxiliary power unit, and an open position in which the cover remains open leaving the support structure and the auxiliary power unit and the ancillary elements thereof exposed and allowing access to the same.

12. Tail cone for aircraft, according to claim 1, wherein the movable fairing comprises reinforcement elements selected from among ring-frames, half ring-frames, stringers, sandwich type coverings and a combination thereof.

13. Tail cone for aircraft, according to claim 2, wherein the support structure is attached directly to the forward ring-frame of the fixed forward section by means of metal attachment fittings.

14. Tail cone for aircraft, according to claim 2, wherein the support structure is attached between the forward ring-frame and the aft ring-frame of the fixed forward section by means of metal attachment fittings.

15. Tail cone for aircraft, according to claim 2, wherein the support structure is attached directly to the aft ring-frame of the fixed forward section by means of metal attachment fittings.

16. Tail cone for aircraft, according to claim 15, wherein there are additionally counter-fittings between the forward ring-frame and the aft ring-frame of the fixed forward section which safely transmit the stresses.

17. Tail cone for aircraft, according to claim 1, wherein the support structure supports the auxiliary power unit by the upper and lateral part thereof by means of at least three anchoring points on the forward fasteners and rear fasteners of the auxiliary power unit.

18. Tail cone for aircraft, according to claim 17, wherein the anchoring points of the auxiliary power unit to the support structure comprise vibration-damping elements on the interior thereof.

19. Tail cone for aircraft, according to claim 1, wherein the element comprising the support structure attached to the anchoring points of the auxiliary power unit comprise elastomeric elements at the ends thereof.

20. Tail cone for aircraft, according to claim 1, wherein the elements comprising the support structure are attached to one another by way of articulated attachment means, means of fixed attachment, means of semifixed attachment and a combination thereof.

21. Tail cone for aircraft, according to claim 1, wherein the element comprising the support structure comprise an assembly of longitudinal elements and an assembly of transverse elements.

22. Tail cone for aircraft, according to claim 21, wherein the longitudinal elements of the support structure are bars, and the transverse elements are ribs.

23. Tail cone for aircraft, according to claim 21, wherein both the longitudinal elements and the transverse elements are bars.

24. Tail cone for aircraft, according to claim 1, wherein the elements comprising the support structure are made in one sole piece.

25. Tail cone for aircraft, according to claim 1, wherein the elements comprising the support structure are made by means of attaching different parts to one another.

26. Tail cone for aircraft, according to claim 3, wherein the telescopic rails additionally rest on the support structure.

27. Tail cone for aircraft, according to claim 1, wherein the exhaust pipe is supported by the support structure independently from the auxiliary power unit by means of conventional fasteners of the exhaust pipe.

28. Tail cone for aircraft, according to claim 1, wherein the air intake is supported independently from the auxiliary power unit, being attached to the support structure by means of conventional fasteners.

29. Tail cone for aircraft, according to claim 1, wherein the air intake is supported independently from the auxiliary power unit, being attached to the fixed forward section by means of conventional fasteners.

30. Tail cone for aircraft, according to claim 1, wherein the air intake is supported independently from the auxiliary power unit, being attached to the support structure and to the fixed forward section by means of conventional fasteners.

31. Tail cone for aircraft, according to claim 2, wherein the rest of the fuselage comprises a closing ring-frame, the forward ring-frame of the fixed forward section comprises a number of primary metal attachment fittings, and said closing ring-frame of the rest of the fuselage comprises a number of secondary metal attachment fittings, the tail cone being attached to the rest of the fuselage by way of the attachment of the primary metal attachment fittings and the secondary metal attachment fittings.

32. Tail cone for aircraft, according to claim 32, wherein the primary metal attachment fittings comprise some primary counter-fittings which transmit the stresses received to the fixed forward section of the tail cone, and the secondary metal attachment fittings comprises some secondary counter-fittings which transmit the stresses received to the rest of the fuselage.

33. Tail cone for aircraft, according to claim 31, wherein the positions of the primary metal attachment fittings of the forward ring-frame of the fixed forward section coincide with the positions of the metal attachment fittings of the support structure with said fixed forward section.

34. Tail cone for aircraft, according to claim 1, wherein the attachment between the tail cone and the rest of the fuselage is made by way of continuous circumferential means of attachment which directly attaches the cover of the tail cone to a cover of the rest of the fuselage and means for reinforcing said circumferential means of attachment.

35. Tail cone for aircraft, according to claim 1, wherein the fixed forward section additionally comprises a firewall bulkhead.
